(19) United States
(12) Patent Application Publication
(10) Pub. No.: US 2008/0083078 A1
(43) Pub. Date: Apr. 10, 2008

(54) Variable-length roller assembly for a rotary scrubber

(76) Inventor: Thomas J. Fellinger, Littleton, CO (US)

Correspondence Address: JOHNS MANVILLE, 10100 WEST UTE AVENUE, PO BOX 625005, LITTLETON, CO, 80162-5005, US

(21) Appl. No.: 11/528,271

(22) Filed: Sep. 27, 2006

(51) Int. Cl. B08B 1/04

(52) U.S. Cl. 15/93.1; 15/23

(57) ABSTRACT

This relates generally to devices used in the removal of excess spray-applied insulation from building components, and more particularly to a variable-length roller assembly for rotary scrubbers used in the removal of such excess insulation. The variable-length roller assembly for a rotary scrubber comprises a base roller assembly defining opposite outer ends and at least one extension roller also defining opposite ends. One end of the at least one extension roller is preferably adapted for removable connection with at least the outer ends of the base roller assembly. The at least one extension roller preferably comprises a plurality of extension rollers, with each defining opposite ends. One end of each extension roller is adapted for removable connection with the outer ends of the base roller assembly. In additional embodiments, the one end of each extension roller is also adapted for removable connection with the other end of each extension roller of the plurality, thus making each extension roller removably connectable with one another in addition to being removably connectable with the opposite outer ends of the base roller assembly. The removable connection of each extension roller with the opposite outer ends of the base roller assembly, and also with each other extension roller, preferably further comprises a securement means for removably securing the roller assembly components to one another. In one embodiment, the securement means comprises a twist-lock. In an alternate embodiment, the securement means comprises a snap-fit.

### CROSS REFERENCE TO RELATED APPLICATIONS

This application is related to co-pending U.S. patent application Ser. Nos. ______, ______ and ______, each filed on ______, 2006, each of which are incorporated by reference herein.

### TECHNICAL FIELD

This relates generally to devices used in the removal of excess spray-applied insulation from building components, and more particularly to a variable-length roller assembly for rotary scrubbers used in the removal of such excess insulation.

### BACKGROUND

Sprayed insulation is commonly used in the construction industry for insulating the open cavities of building walls, floors, ceilings, attics and other areas. Insulation materials, such as loose fiberglass, rock wool, mineral wool, fibrous plastic, cellulose, ceramic fiber, etc., that is combined with an adhesive or water, are sprayed from an applicator into such open cavities to reduce the rate of heat loss or gain there-though. The adhesive properties of the insulation mixture, resulting from the combination of the insulation materials with the adhesive or water, allow it to adhere to vertical or overhanging surfaces, thus allowing for an application of insulation prior to the installation of wallboard and similar cavity enclosing materials.

In applying sprayed insulation into open cavities, an installer typically holds an outlet end of the applicator towards the open cavity and then sprays the insulation and adhesive mixture into the cavity until the cavity is filled. To ensure that the cavity is completely filled, an installer typically sprays an excess amount of the mixture into the cavity such that an excess quantity (i.e. overfill) of the sprayed insulation has accumulated beyond an opening of the cavity defined by the cavity's confining boundaries, i.e. beyond the wall studs, floor or ceiling joists or other framing members defining the cavity. Such an excess amount or overfill is often necessary to ensure a complete fill of the cavity with the insulation mixture, thus minimizing the presence of gaps or voids therein and ensuring that the claimed thermal or acoustic performance, as specified by the manufacturer of the insulation product, is met.

However, to allow for the installation of wallboard, a vapor retarder or other surface materials over the cavity after receiving the insulation mixture, the excess or overfill insulation must be compacted into the cavity or removed therefrom to allow the surface materials to lay flush against the framing members. Excess insulation mixture located on the faces or outer surfaces of the framing members must be removed as well. The excess or overfill sprayed insulation mixture is thus removed or “scrubbed” from the cavity and faces of the framing members with a rotary scrubber to define an outer surface or boundary of the mixture at the cavity's opening lying preferably co-planar with the faces of the framing members.

The rotary scrubber generally comprises a hand-held device having a rotating, motor-driven roller assembly attached thereto. The roller assembly, typically located at a forward end of a framework of the device and including a cylindrical brush or textured roller, is driven to rotate by a motor and associated drive belt, also located on the device. The drive belt is in contact with the roller assembly via a pulley or channel defined in the outer surface of the brush or roller. The rotating roller assembly preferably has an end-to-end length that spans or exceeds the width of a building cavity as defined by the framing members. Thus, during the removal process, the rotating roller assembly is positioned against the faces of the framing members to span the width of the cavity. The rotating roller assembly is then pulled along the framing members, preferably in a direction about parallel thereto, such that the brush or roller of the assembly contacts and scrubs the excess of overfill insulation mixture from the cavity and framing members, thus creating the outer surface or boundary of the insulation that is preferably co-planar with the framing members.

Although various rotary scrubbers are presently available to facilitate the removal of excess or overfill sprayed insulation materials from building cavities, such scrubbers are not readily adaptable for the removal of insulation materials from building cavities of multiple width. Presently-available scrubbers typically utilize a roller assembly having a fixed end-to-end length that preferably spans or exceeds the width of the framework defining the width of the building cavity. For example, if the building cavity comprises a wall cavity defined by wall studs located about every 16 inches, then the roller assembly of the rotary scrubber preferably has a length of at least 16 inches to span the width of the cavity defined by the studs. Similarly, if the wall cavity is defined by wall studs located about every 24 inches, then the roller assembly of the rotary scrubber preferably has a length of at least 24 inches to span the width of the cavity defined by the studs.

However, if other lengths of the roller assembly are desired, i.e. a shorter length for the scrubbing of confined areas of a closet or a longer length for scrubbing building cavities of extended width or multiple building cavities simultaneously, the roller assembly of inappropriate length is removed and one or appropriate length is substituted therefore. However, because the roller assemblies of presently-available scrubbers are typically attached to such scrubbers via a shaft and numerous nuts, bolts, washers, bearing and race assemblies and/or other components, the removal and replacement of a roller assembly from a presently-available scrubber requires the disassembly and re-assembly of the foregoing components. Such a disassembly and re-assembly of these components results in operational down-time during scrubbing operations, thus resulting in increased labor costs for insulation scrubbing operations. The replacement of any roller assembly to accommodate building cavities of multiple widths during scrubbing operations also requires the need for tools and a stockpile of multiple roller assemblies of various lengths, thus again resulting in increased project costs.

Thus, what is needed is a rotary scrubber roller assembly that accommodates various widths of building cavity without requiring a disassembly of the scrubber itself. The roller assembly should allow for changes in its length without requiring tools or a stockpile of multiple assemblies of various lengths. The roller assembly, accommodating various widths of building cavities, should have a structure to allow for its utilization on a variety of scrubbers. This fulfills these foregoing needs.

### SUMMARY

This relates generally to devices used in the removal of excess spray-applied insulation from building components, and more particularly to a variable-length roller assembly for rotary scrubbers used in the removal of such excess insulation. Rotary scrubbers having one arm or a pair or arms each utilize a variable-length roller assembly whereby the rearward end of each arm is connected to a housing or other structure while the variable-length roller assembly is preferably rotatably associated with the forward end of the arm or arms. For each scrubber, a motor is preferably connected to the housing and operably associated with a drive belt or a pair of drive belts, with the drive belt or drive belts in one embodiment entrained around the arm or arms, respectively, and operably associated with the variable-length roller assembly. One or more handles are also preferably connected to each respective scrubber to facilitate a secure grip thereof by respective users.

The variable-length roller assembly for each scrubber comprises a base roller assembly defining opposite outer ends and at least one extension roller also defining opposite ends. One end of the at least one extension roller is preferably adapted for removable connection with at least the opposite outer ends of the base roller assembly. For scrubbers utilizing either a single arm or a pair of arms, the at least one extension roller preferably comprises a plurality of extension rollers defining opposite ends. One end of each extension roller is adapted for removable connection with the opposite outer ends of the base roller assembly. In additional embodiments, the one end of each extension roller is also adapted for removable connection with the other end of each extension roller of the plurality, thus making each extension roller removably connectable with one another in addition to being removably connectable with the base roller assembly.

In relation to rotary scrubbers utilizing a single arm, the base roller assembly preferably comprises first and second rollers rotatably associated with the arm of the scrubber, with each roller defining inner and outer ends. The inner ends of the respective rollers are located proximal to the arm of the scrubber while the outer ends thereof define the opposite outer ends of the base roller assembly. In relation to rotary scrubbers utilizing a pair of arms, the base roller assembly preferably comprises a central roller and a pair of outer rollers rotatably associated with the pair of arms of the scrubber. The central roller defines opposite ends located proximal to the arms of the pair, with each outer roller defining inner and outer ends. The respective inner ends of the outer rollers are preferably located proximal the arms of the pair while the respective outer ends of the outer rollers define the opposite outer ends of the base roller assembly.

For scrubber embodiments utilizing either a single arm or a pair of arms, a roller assembly shaft extends through a roller assembly bore defined at the forward end of each arm and at least into each roller of the base roller assembly to define the rotatable association of the assembly with the arm or pair of arms of the respective scrubbers. In one embodiment, each roller of the base roller assembly rotates about the shaft connected to the arm or arms of the scrubber via thrust bearing and race assemblies located between the shaft and each roller. In another embodiment, each roller of the base roller assembly is affixed to the shaft, with the shaft rotatably connected to the arm or arms of the scrubber via one or more press-fit bearing and race assemblies located there-between.

To accommodate the operable relation between the base roller assembly and the scrubber's drive belt or belts, in one embodiment, the outer surface of each roller end of the base roller assembly located adjacent to an arm or arms of the scrubber defines at least one circumferal inlet that together define a groove or grooves in the base roller assembly for operable engagement with the drive belt or belts. Alternatively, roller supports located at roller ends of the base roller assembly adjacent to the arm or arms of the scrubber each define a pulley surface that together define a pulley or pulleys in the base roller assembly for operable engagement with the drive belt or belts.

The at least one extension roller is adapted for removable connection with at least the opposite outer ends of the base roller assembly. The at least one extension roller preferably comprises a plurality of extension rollers, with each extension roller adapted for removable connection with the opposite outer ends of the base roller assembly. In additional embodiments, each extension roller is also adapted for removable connection with each other extension roller of the plurality, thus making each extension roller removably connectable with one another in addition to being removably connectable with the opposite outer ends of the base roller assembly. Thus, the removable connection of each extension roller with the opposite outer ends of the base roller assembly preferably comprises a circumferal protuberance located at one end of each extension roller, and a receiver located at the opposites outer ends of the base roller assembly.

In additional embodiments, the removable connection of each extension roller with the opposite outer ends of the base roller assembly, and also with each other extension roller preferably comprises a circumferal protuberance located at one end of each extension roller, and the receiver located at the opposites outer ends of the base roller assembly and also at the other end of each extension roller. Each protuberance and receiver is adapted for mating engagement with one another. The removable connection of each extension roller with the opposite outer ends of the base roller assembly, and also with each other extension roller, preferably further comprises a securement means for removably securing the roller assembly components to one another. In one embodiment, the securement means comprises a twist-lock. In an alternate embodiment, the securement means comprises a snap-fit.

The variable-length roller assembly utilizes base assembly and extension rollers comprised of durable materials. In one embodiment, each roller of the variable-length roller assembly (i.e., each roller of the base roller assembly and each extension roller) is comprised of a polyurethane material having a durometer hardness of between about 60 A and about 85 D, preferably about 75 D. It is understood, however, that polyurethane rollers of other durometer hardness may be utilized, as well as rollers comprised of other materials (i.e., aluminum, plastic, rubber, etc). Each roller of the variable-length roller assembly (i.e., each roller of the base roller assembly and each extension roller) preferably defines a textured outer surface. The textured outer surface may comprise any texture sufficient for the removal of sprayed insulation or other materials. In one embodiment, each roller has a plurality of ribs defined in its outer surface. The outer surface of each roller defines between about 15 ribs and about 35 ribs, preferably about 22 ribs. The ribs may be machined or cut into the outer surface of each roller, or the ribs may be formed by a molding or extrusion process. Each rib may have a triangular cross-section, a cross-section defining at least two right angles, or a cross-section defining a blade.

### BRIEF DESCRIPTION OF THE DRAWINGS

FIG. 1 is a plan view illustrating the variable-length roller assembly utilized with a scrubber having one arm;

FIG. 2 is a plan view illustrating the variable-length roller assembly utilized with a scrubber having a pair of arms;

FIG. 3 is a sectional assembly view of the variable-length roller assembly of the scrubber illustrated in FIG. 1;

FIG. 4 is a sectional assembly view of the variable-length roller assembly of the scrubber illustrated in FIG. 2;

FIG. 5 is a sectional view of the base roller assembly of FIG. 3 illustrating an alternate rotational association between the rollers, shaft and arm;

FIG. 6 is a sectional view of the base roller assembly of FIG. 4 illustrating an alternate rotational association between the rollers, shaft and arms;

FIG. 7 is a sectional view of the variable-length roller assembly of the scrubber illustrated in FIG. 1 showing the groove defined by the inner circumferal inlets and also showing one embodiment of the securement means;

FIG. 8 is a sectional view of the variable-length roller assembly of the scrubber illustrated in FIG. 2 showing the grooves defined by the inner and outer circumferal inlets and also showing the one embodiment of the securement means;

FIG. 9 is a side view of one of the arms of the scrubber illustrating its relationship with the central roller and drive belt;

FIG. 10 is a sectional view illustrating an alternate embodiment of the securement means of the variable-length roller assembly;

FIG. 11 is an end view of the variable-length roller assembly having an outer surface defining ribs having a triangular cross-section;

FIG. 12 is an end view of the variable-length roller assembly having an outer surface defining ribs having a cross-section defining at least two right angles; and

FIG. 13 is an end view of the variable length roller assembly having an outer surface wherein each rib has a cross-section defining a blade.

### DESCRIPTION OF THE EMBODIMENTS

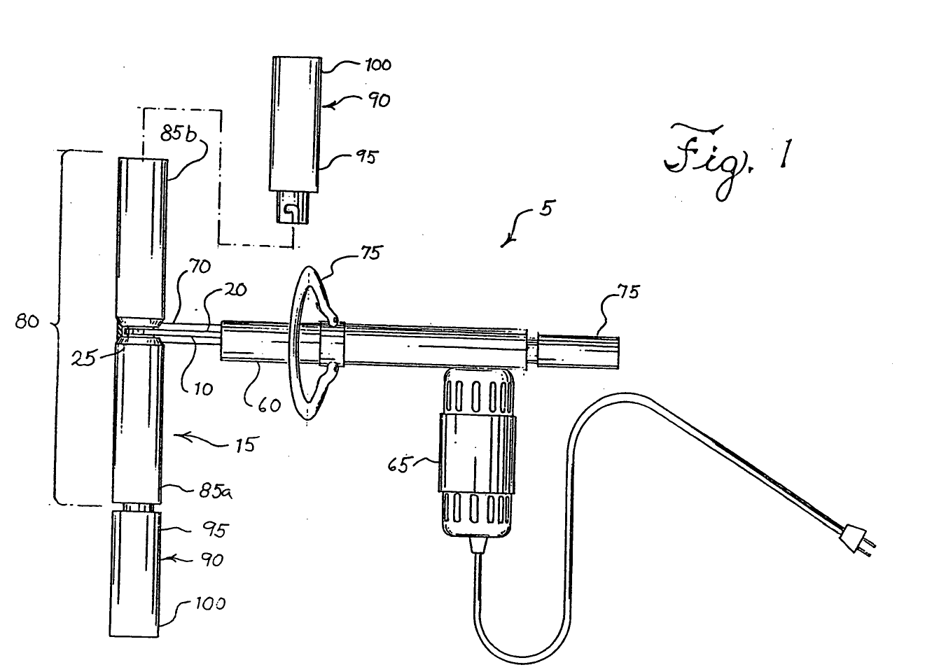

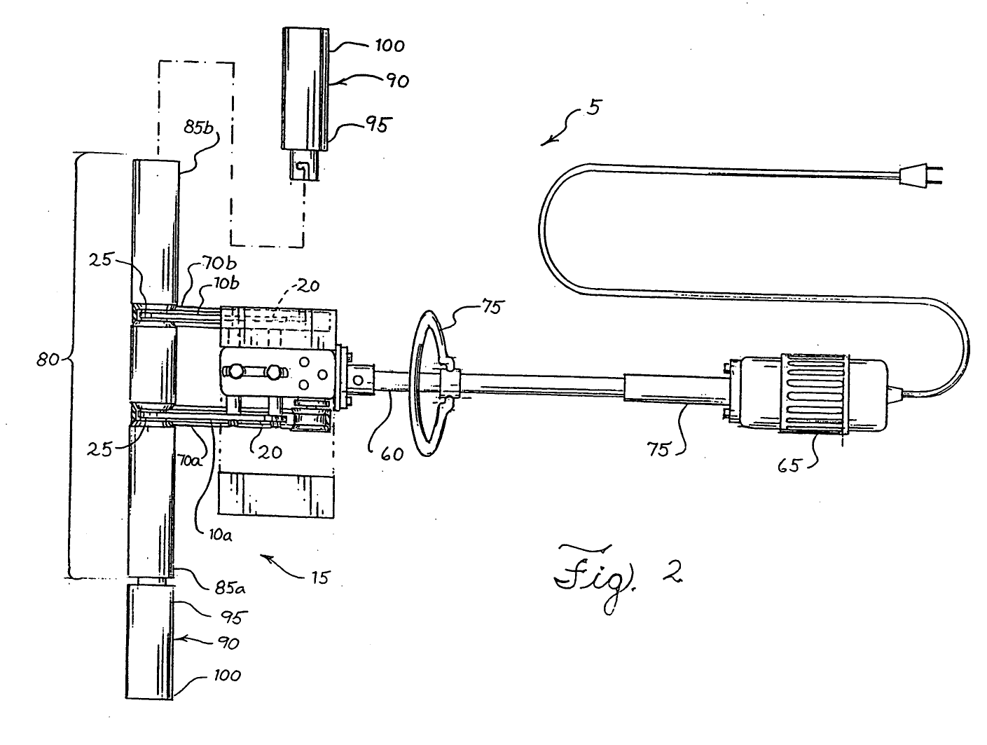

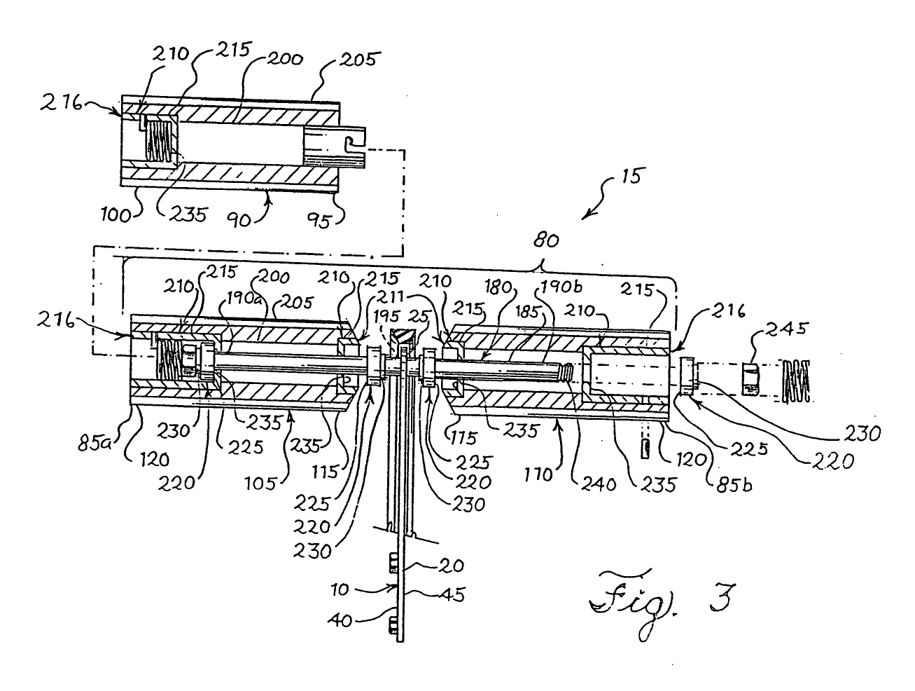

This relates generally to devices used in the removal of excess spray-applied insulation from building components, and more particularly to a variable-length roller assembly for rotary scrubbers used in the removal of such excess insulation. FIGS. 1 and 2 respectively illustrate the basic components of rotary scrubbers 5 having at least one arm, i.e., one arm 10 and a pair or arms 10a and 10b, each utilizing a variable-length roller assembly 15. Referring also to FIGS. 3, 4 and 9, the arm 10 and pair of arms 10a and 10b each define rearward and forward ends 20 and 25 and upper and lower edges 30 and 35, with arm 10 defining sides 40 and 45 and the pair of arms 10a and 10b defining inner and outer sides 50 and 55. Although FIG. 9 illustrates a side view of arm 10 and by example, it is understood that arms 10a and 10b possess respectively the same structure.

Referring again to FIGS. 1 and 2, the rearward end 20 of each arm is connected to a housing 60 or other structure while the variable-length roller assembly 15 of each scrubber 5 is preferably rotatably associated with the forward end 25 of the at least one arm (i.e., arm 10 or arms 10a and 10b). For each scrubber 5, a motor 65 is preferably connected to the housing 60 and operably associated with a drive belt 70 or a pair of drive belts 70a and 70b (shown in section), with the drive belt or drive belts in one embodiment entrained around the arm or arms, respectively, and operably associated with the variable-length roller assembly 15. One or more handles 75 are also preferably connected to each respective scrubber to facilitate a secure grip thereof by respective users.

As illustrated in FIGS. 1 and 2, the variable-length roller assembly 15 for each scrubber comprises a base roller assembly 80 defining opposite outer ends 85a and 85b and at least one extension roller 90 defining opposite ends 95 and 100. One end 95 of the at least one extension roller 90 is preferably adapted for removable connection with at least the opposite outer ends 85a and 85b of the base roller assembly 80. For scrubbers utilizing both a single arm and a pair of arms, the at least one extension roller 90 preferably comprises a plurality of extension rollers 90 defining opposite ends. One end 95 of each extension roller is adapted for removable connection with the opposite outer ends 85a and 85b of the base roller assembly 80. In additional embodiments, the one end 95 of each extension roller is also adapted for removable connection with the other end 100 of each extension roller of the plurality, thus making each extension roller removably connectable with one another in addition to being removably connectable with the base roller assembly. Although FIGS. 1 and 2 illustrate one end 95 of each extension roller of the plurality adapted for removable connection with the opposite outer ends of the base roller assembly and with the other end 100 of each extension roller of the plurality, it is understood that the end 100 of each extension roller may be adapted for removable connection with the opposite outer ends of the base roller assembly and with the end 95 of each extension roller of the plurality as well.

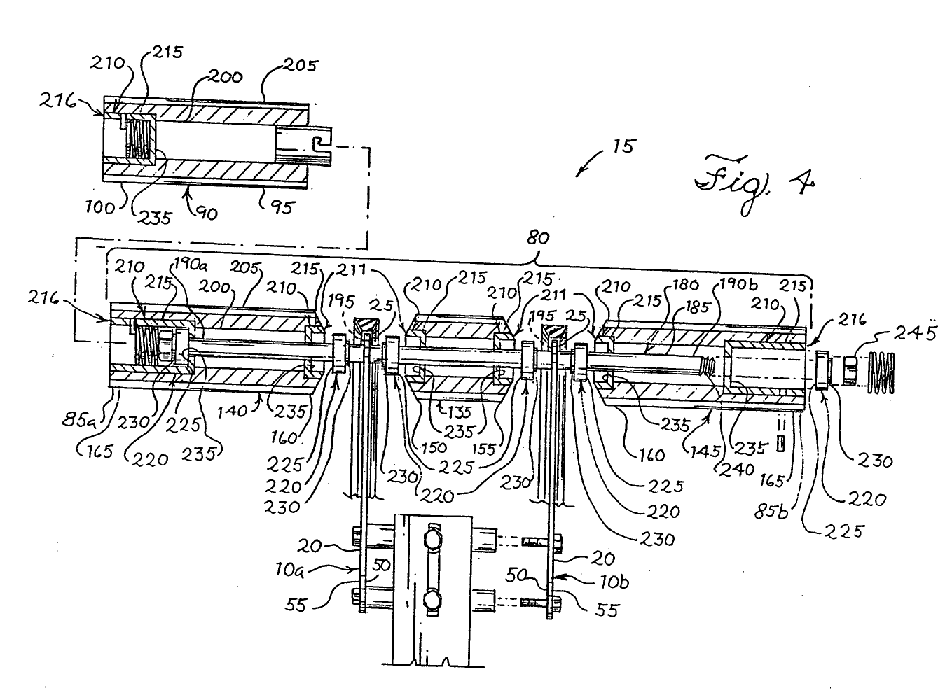

FIGS. 3 and 4 are sectional assembly views of the variable-length roller assemblies 15 of the scrubbers of FIGS. 1 and 2. As illustrated in FIG. 3 in relation to rotary scrubbers utilizing a single arm 10, the base roller assembly 80 preferably comprises first and second rollers 105 and 110 rotatably associated with the arm 10 of the scrubber, with the first and second rollers each defining inner and outer ends 115 and 120. The inner ends 115 of the respective rollers 105 and 110 are located proximal to the arm 10 of the scrubber while the outer ends 120 thereof define the opposite outer ends 85a and 85b of the base roller assembly 80.

As illustrated in FIG. 4 in relation to rotary scrubbers utilizing a pair of arms 10a and 10b, the base roller assembly 80 preferably comprises a central roller 135 and a pair of outer rollers 140 and 145 rotatably associated with the pair of arms of the scrubber. The central roller 135 defines opposite ends 150 and 155 located proximal to the arms 10a and 10b of the pair, with each outer roller 140 and 145 defining inner and outer ends 160 and 165. The respective inner ends 160 of the outer rollers 140 and 145 are preferably located proximal the arms 10a and 10b of the pair while the respective outer ends 165 of the outer rollers define the opposite outer ends 85a and 85b of the base roller assembly 80.

Regardless of whether the scrubber utilizes a single arm or a pair of arms, the base roller assembly 80 has an overall length of from about 2 inches to about 60 inches, preferably from about 18 inches to about 62 inches. For scrubbers utilizing a single arm, each of the first and second rollers 105 and 110 have a length of from about 1 inch to about 30 inches, preferably from about 9 inches to about 31 inches. Each extension roller 90 for scrubbers utilizing a single arm has a length of from about 1 inch to about 23 inches, preferably about 7.5 inches. For scrubbers utilizing a pair of arms, the central roller 135 has a length of from about 2 inches to about 62 inches, preferably about 3 inches, with each outer roller 140 and 145 preferably having a length of from about 1 inch to about a 29.5 inches. Each extension roller 90 for scrubbers utilizing a pair of arms has a length of from about 1 inch to about 28.5 inches, preferably about 7.5 inches. Although the foregoing recites preferred roller lengths for various scrubber embodiments, it is understood that each roller, regardless of scrubber embodiment, may nonetheless have any length. Thus, each of the first and second rollers 105 and 110, each of the central 135 and outer rollers 140 and 145, and each extension roller 90, can have any length. It is further understood that the base roller assembly 80 can have any overall length as well.

As illustrated respectively in FIGS. 3 and 4, for scrubber embodiments utilizing either a single arm 10 or a pair of arms 10a and 10b, a roller assembly shaft 180, defining an outer surface 185 and opposite ends 190a and 190b, extends through a roller assembly bore 195 defined at the forward end 25 of each arm. The shaft 180 also extends at least into each roller of the base roller assembly 80 to define the rotatable association of the assembly with the arm 10 or pair of arms 10a and 10b of the respective scrubbers. Thus, for scrubbers utilizing a single arm 10, the shaft 180 extends through the roller assembly bore 195 and at least into the first and second rollers 105 and 110 of the base roller assembly 80 (FIG. 3). For scrubbers utilizing a pair of arms 10a and 10b, the shaft 180 extends through the roller assembly bore 195 of each arm, into and through the central roller 135, and at least into the outer rollers 140 and 145 of the base roller assembly 80 (FIG. 4). In both scrubber embodiments, each roller assembly bore 195 is preferably about 0.505 inches in diameter while the roller assembly shaft 180 preferably defines an outer surface 185 having a corresponding diameter of about 0.5 inches. It is understood, however, that bores and corresponding shafts of other diameters may be utilized as well.

For scrubber embodiments utilizing either a single arm 10 or a pair of arms 10a and 10b, the roller assembly shaft 180 has a length to adequately support each roller of the base roller assembly 80 and the plurality of extension rollers 90 removably connected to the opposite outer ends 85a and 85b thereof. Thus, for scrubber embodiments utilizing a single arm 10, the roller assembly shaft 180 has a length sufficient to extend at least through the arm and through at least about one half of the length of each of the first and second rollers 105 and 110, and more preferably at least through the arm and at least about two thirds of the length of each. For scrubber embodiments utilizing a pair of arms 10a and 10b, the roller assembly shaft 180 has a length sufficient to extend at least through the central roller 135, each arm of the pair and through at least about one half of the length of each of the pair of outer rollers 140 and 145. More preferably, the shaft 180 has a length that extends at least through the central roller 135, each arm of the pair and through at least about two thirds of the length of each of the pair of outer rollers 140 and 145.

For example, for a scrubber utilizing a single arm 10 having a width of about 0.5 inch and first and second rollers 105 and 110 each having a length of about 8 inches (i.e., a base roller assembly length of about 16 inches), the roller assembly shaft 180 has a length of at least about 8.5 inches, and more preferably a length of at least about 11 inches. For a scrubber utilizing a pair of arms 10a and 10b each having a width of about 0.5 inch, a central roller 135 having a length of about 3 inches, and a pair of outer rollers 140 and 145 each having a length of about 6 inches (i.e., a base roller assembly length of about 16 inches) the roller assembly shaft has a length of at least about 10 inches, and more preferably a length of at least about 12 inches. It is understood, however, that the first and second rollers 105 and 110 of FIG. 3 and that the central 135 and outer rollers 140 and 145 of FIG. 4 may each have any length to comprise a base roller assembly 80 of other lengths as well, thus requiring a shaft of a length sufficient to accommodate that of the base roller assembly. It is also understood that the shaft 180 of each scrubber embodiment may accommodate a scrubber arm 10 or arms 10a and 10b of any width, as well as any fasteners utilized to connect the shaft to the arm or arms of the respective scrubbers, to be further discussed.

For the scrubber embodiments utilizing either the single arm 10 or pair of arms 10a and 10b respectively illustrated in FIGS. 3 and 4, each roller of the variable-length roller assembly 15, to include the rollers of the base roller assembly 80 and the at least one extension roller 90, preferably defines about a 1 and ¼ inch inside diameter and about a 2 inch outside diameter to define inner and outer roller surfaces 200 and 205, respectively. However, it is understood that each roller of the variable-length roller assembly may define an outside diameter of between about 1 inch and about 5 inches to define the outer roller surface as well. A circumferal void 210, defining an inner circumferal surface 215 having a diameter greater than each roller's inside diameter but less than the outside diameter, is preferably defined in the opposite ends of each roller of the base roller assembly 80, as well as in the other end 100 of each extension roller 90 for embodiments having the extension rollers removably connectable with one another in addition to being removably connectable with the base roller assembly.

For the inner ends 115 of the first and second rollers 105 and 110 (FIG. 3), as well as for the opposite ends 150 and 155 of the central roller 135 and inner ends 160 of the outer rollers 140 and 145 (FIG. 4), a seat 211 is located in the circumferal void 210 that engages the circumferal surface 215, with the seat 211 accommodating the placement of at least a thrust bearing and race assembly 220 therein. Referring again to both FIGS. 3 and 4, for the opposite outer ends 85a and 85b of the base roller assembly 80, and for the other end 100 of each extension roller in embodiments having extension rollers removably connectable with one another in addition to being removably connectable with the base roller assembly, a receiver 216 is located in the circumferal void that engages the circumferal surface 215.

The receivers 216 located at the opposite outer ends 85a and 85b of the base roller assembly 80 are adapted for removable connection with the extension rollers 90 (to be further discussed) and are also adapted to accommodate the placement of the thrust bearing and race assembly 220 therein. In embodiments of the variable-length roller assembly 15 having extension rollers 90 adapted for a removable connection with other extension rollers of the plurality in addition to the base roller assembly, the receiver 216 is also located at the other end 100 of each extension roller 90 and is adapted for removable connection with other extension rollers of the plurality (also to be further discussed). The seat 211 and receiver 216 are each preferably comprised of aluminum, with each preferably bonded to the inner circumferal surfaces 215 of the respective rollers with an adhesive. However, it is understood that the seat 211 and receiver 216 may be comprised of any lightweight, rigid material as well. It is further understood that each may be connected to the respective roller using a resistance fit or any mechanical means understood in the art. Each seat and receiver may also be unitary with or defined in each roller itself as well.

Each thrust bearing and race assembly 220 has an inner race and offset, outer race to define opposite sides 225 and 230. Each thrust bearing and race assembly 220, located between the outer surface 185 of the roller assembly shaft 180 and the respective seat 211 and receiver 216 of each roller of the base roller assembly 80, allows the rollers of the base roller assembly 80 assembly to thus rotate about the shaft 180. Both the seat 211 and receiver 216 define an abutment 235 located at a predetermined distance from the end of each roller. For each roller of the base roller assembly 80, the abutment 235 is adapted for contact with the one side 225 of the thrust bearing and race assembly 220 (i.e., the side of the offset, outer race) while for each extension roller 90 having a receiver 216, the abutment is adapted for contact with a compression spring (to be further discussed).

Referring respectively to the base roller assemblies 80 of FIGS. 3 and 4, for the seats 211 located at the inner ends 115 of the first and second rollers 105 and 110 proximal to the outer sides 40 and 45 of the arm 10, as well as for those located at the opposite ends 150 and 155 of the central roller 135 and the inner ends 160 of the outer rollers 140 and 145 proximal to the inner and outer sides 50 and 55 of the arms 10a and 10b, respectively, the distance of a given abutment 235 from the ends of the rollers is less than the width of a given thrust bearing and race assembly 220. This reduced distance allows the other side 230 of the thrust bearing and race assembly 220, i.e. the side not in contact with a roller's abutment 235, to contact to the respective sides of the arms, thus precluding any rotational interference between the ends of the rollers with the arms when the base roller assembly 80 and shaft 180 are secured to the arms themselves.

For the receivers 216 located at the outer ends 120 of the first and second rollers 105 and 110 of the base roller assembly 80 of FIG. 3, as well for those located at the outer ends 165 of the outer rollers 140 and 145 of the base roller assembly 80 of FIG. 4, the distance of the abutment 235 from the respective ends of the rollers defines a receiver depth that is preferably determined by the preferred shaft length. Thus, for scrubber embodiments utilizing a roller assembly shaft 180 of a length sufficient to extend through at least about one half of the length of each of the first and second rollers 105 and 110 of FIG. 3, the distance of the abutment 235 from the outer ends of the respective rollers (i.e., the receiver depth) is about one half of each roller's length. For scrubber embodiments utilizing a roller assembly shaft 180 of a length sufficient to extend through at least about two thirds of the length of each of the first and second rollers 105 and 110 of FIG. 3, the distance of the abutment 235 from the outer ends of the respective rollers (i.e., the receiver depth) is about one third of each roller's length. Also, for each extension roller 90 having a receiver 216, the distance of the abutment 235 from the end 100 of each roller, again defining the receiver depth, is about one half, and preferably about one third of each roller's length as well. However, it is understood that the receivers 216 of the base roller assembly 80 and of any extension roller 90 may each have an abutment 235 located at any distance from the respective roller's end to define any receiver depth, regardless of roller length.

To secure the base roller assembly 80 and shaft 180 to the arm 10 of FIG. 3 or to the arms 10a and 10b of FIG. 4, the shaft preferably defines threads 240 at its opposite ends 190a and 190b such that nuts 245 threaded thereto exert lateral forces against the sides of the thrust bearing and race assemblies 220 (via the side of the offset outer race) located at the outer ends 120 of the first and second rollers 105 and 110 and at the outer ends 165 of the outer rollers 140 and 145, respectively. Thus, when the nuts 245 are fastened to the threaded ends of the roller assembly shaft 180 and against the thrust bearing and race assemblies 220 located at the outer ends of the respective base roller assemblies, the forces created thereby are transmitted laterally through the rollers and remaining bearing assemblies via the abutments 235, and to the arm 10 or arms 10a and 10b, to secure each assembly thereto while avoiding the occurrence of any rotational interference with adjacent roller ends.

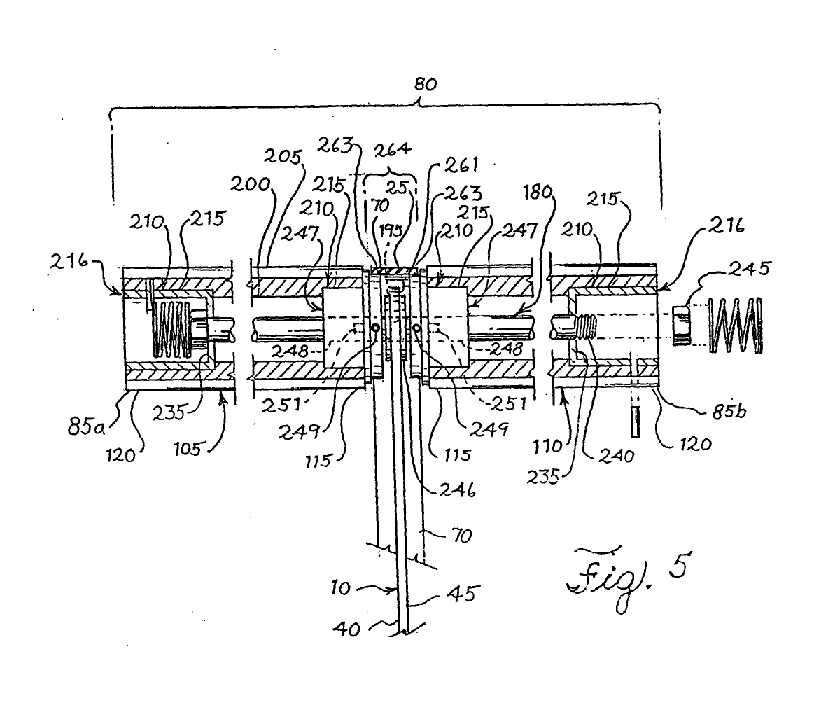

While FIGS. 3 and 4 illustrate that each roller of the base roller assembly 80 rotates about the shaft 180 connected to the single 10 or pair of arms 10a and 10b of the scrubber via thrust bearing and race assemblies 220 located between the shaft and the respective seats 211 and receivers 216 of each roller, FIGS. 5 and 6 illustrate each roller of the base roller assembly affixed to the shaft, with the shaft rotatably connected to the single or pair of arms of the scrubber via one or more bearing and race assemblies located there-between. As illustrated therein, a press-fit bearing and race assembly 246 is located between the shaft 180 and the roller assembly bore 195 defined at the forward end 25 of the arm 10 or pair of arms 10a and 10b to allow the shaft to rotate in relation thereto. Each roller of the base roller assembly 80 again preferably defines about a 1 and ¼ inch inside diameter and about a 2 inch outside diameter to define inner and outer roller surfaces 200 and 205 respectively. Again however, it is understood that each roller may define an outside diameter of between about 1 inch and about 5 inches to define the outer roller surface as well. A circumferal void 210, again defining an inner circumferal surface 215 having a diameter greater than each roller's inside diameter but less than the outside diameter, is again preferably defined at the opposite ends of each roller.

However, the circumferal voids 210 defined in at least the inner ends 115 of the respective first and second rollers 105 and 110 (FIG. 5), as well as in the opposite ends 150 and 155 of the central roller 135 and inner ends 160 of the respective outer rollers 140 and 145 (FIG. 6), each preferably accommodate the placement of a roller support 247 therein in lieu of the seat, with each roller support defining a support bore 248 therein adapted for mating engagement with the shaft 180. A set-screw 249 intersects the support bore 248 of each support 247 for engagement with a respective recess 251 defined on the shaft. Each set-screw 249, when engaged with an associated recess 251 of the shaft 180, thus releasably affixes each roller of the base roller assembly 80 to the shaft.

Because of the presence of the press-fit bearing and race assemblies 246 located between the respective arms and the shaft, the thrust bearing and race assemblies 220 are absent from the receivers 216 located at the outer ends 120 of the respective first and second rollers 105 and 110 (FIG. 5) and at the outer ends 165 of the respective outer rollers 140 and 145 (FIG. 6), with the nuts 245 fastened to the threads 240 of the shaft and against the abutments 235 of the receivers. Each roller support 247 is preferably comprised of aluminum and preferably bonded to the respective inner circumferal surfaces 215 of each roller with an adhesive. However, it is understood that the support may be comprised of any lightweight material as well. It is further understood that each may be connected to the respective roller using a resistance fit or any mechanical means understood in the art.

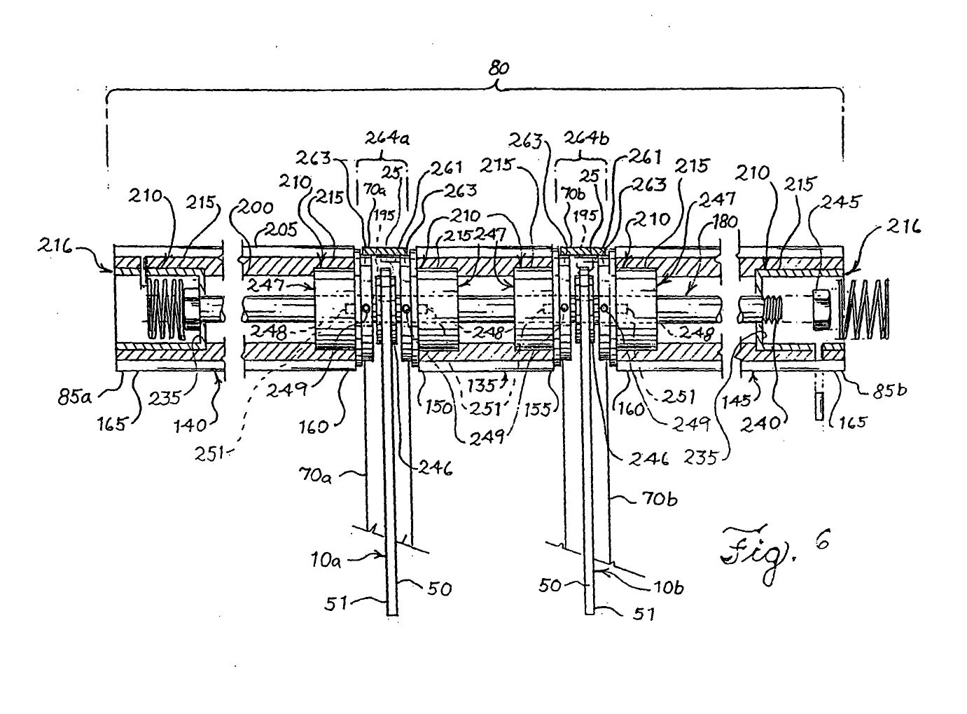

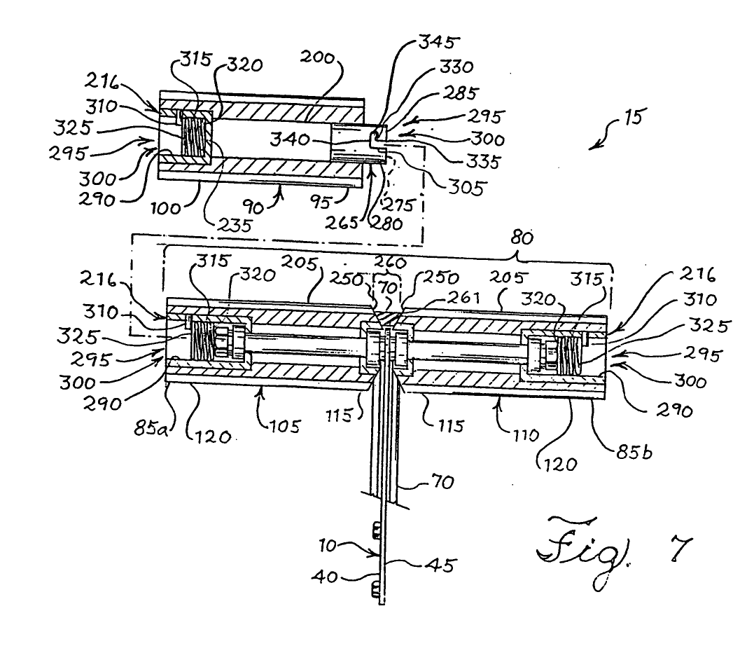

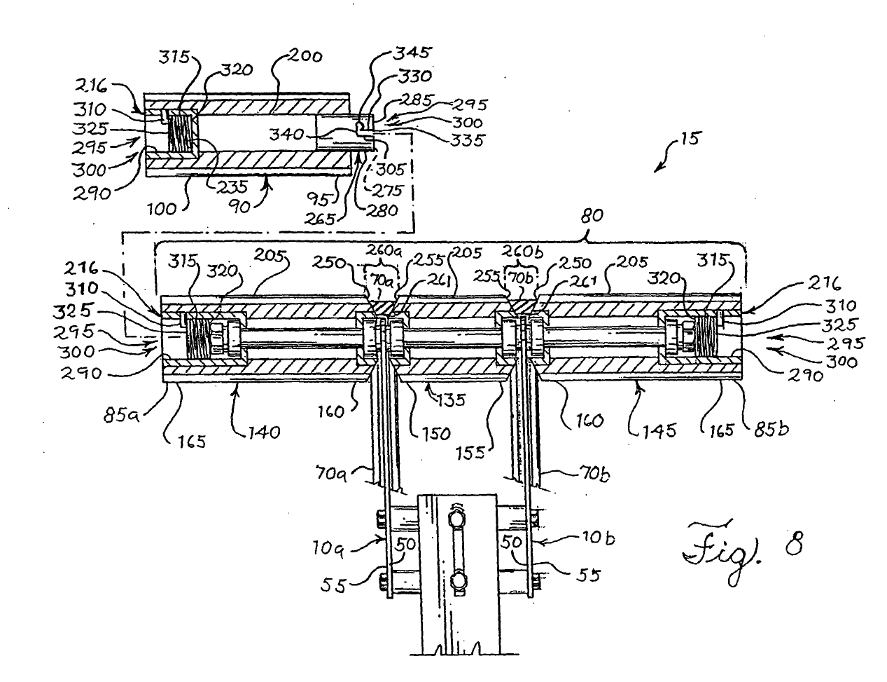

In addition to having circumferal voids 210 defined in the rollers of the respective base roller assemblies 80 to accommodate the respective seats 211, roller supports 247 or receivers 216, the rollers of each assembly define other features as well to accommodate the operable relation of the scrubber's drive belt 70 or belts 70a and 70b therewith. Referring to FIG. 7, the inner ends 115 of the first and second rollers 105 and 110 located proximal to the sides 40 and 45 of the arm 10 each define an inner circumferal inlet 250 in the outer surface 205 of the roller. The inner circumferal inlets 250 of the first and second rollers 105 and 110 together define a groove 260 in the base roller assembly 80 for operable engagement with the drive belt 70. Referring to FIG. 8, the opposite ends 150 and 155 of the central roller 135 located proximal to the inner side 50 of each of the pair of arms 10a and 10b each thus define an outer circumferal inlet 255 in the outer surface 205 of the roller. The inner ends 160 of the outer rollers 140 and 145 located proximal to the outer sides 55 of the arms 10a and 10b each define an inner circumferal inlet 250 in the respective outer surfaces 205 of each roller. The outer and inner circumferal inlets 255 and 250 of the central 135 and two outer rollers 140 and 145 together define a pair of grooves 260a and 260b in the base roller assembly 80 for operable engagement with the pair of drive belts 70a and 70b. The groove 260 of FIG. 3 and the pair of grooves 260a and 260b of FIG. 4 thus defines the operable relationship of each belt with the variable-length roller assembly 15 of each respective scrubber.

Each circumferal inlet 250 and 255 defines a cross-section and depth such that their combination defines a groove 260 or grooves 260a and 260b having a cross-section and depth sufficient to accommodate the drive belt 70 or belts 70a and 70b therein. In the embodiments illustrated in FIGS. 7 and 8, each circumferal inlet 250 and 255 preferably defines a downwardly sloped surface to define a groove 260 or grooves 260a and 260b having a substantially “V” or trapezoidal cross-section, thus accommodating a belt of like cross-section therein. However, it is understood that the circumferal inlets may define grooves having any cross-sectional shape to accommodate a belt of similar cross-section. For example, if the belt has a square or rectangular cross-section, then each circumferal inlet preferably defines a right angle to define a groove having a substantially square or rectangular cross-section. Similarly, if the belt has a circular cross-section, then each circumferal inlet preferably defines a groove having a cross-section defining a chord or semi-circle.

Regardless of the shape of the groove cross-section defined by the circumferal inlets 250 and 255, as illustrated in FIGS. 7 and 8, because the groove 260 or grooves 260a and 260b of a variable-length given roller assembly 15 are defined by circumferal inlets located on opposite sides of the arm 10 or pair of arms 10a and 10b, a gap 261 is defined in each groove due to the presence of the arm located there-between. Referring to FIG. 9 in addition to FIGS. 7 and 8, to ensure that a drive belt, when engaged with a given groove, does not contact the upper and lower edges 30 and 35 or rounded forward end 25 of a given arm (only arm 10, belt 70 and central roller 135 illustrated by example) located respectively within a given gap 261, the depth of each groove (i.e., groove 260) is defined by a groove radius GR, as measured from an axis 262 defined by the roller assembly bores 195 of the arm or arms, that exceeds the end radius ER of the arm's rounded end defining each arm's top-to-bottom depth. Also, to ensure that the given drive belt engaged with a given groove is not drawn into the respective gap 261 defined therein, each groove defines a width that both accommodates the drive belt and exceeds that of the gap.

Alternatively, referring again to FIG. 5, the roller supports 247 located at the inner ends 115 of the first and second rollers 105 and 110 each define a pulley surface 263. The pulley surfaces 263 of the first and second rollers 105 and 110 together define a pulley 264 in the base roller assembly 80 for operable engagement with the drive belt 70. Referring again to FIG. 6, the roller supports 247 located at the opposite ends 150 and 155 of the central roller 135 and at the inner ends 160 of the outer rollers 140 and 145 each define a pulley surface 263 to define respective pulleys 264a and 264b in the base roller assembly 80 for operable engagement with the drive belts 70a and 70b. While FIGS. 7 and 8 illustrate a groove defined by inlets located at respective roller ends and while FIGS. 5 and 6 illustrate a pulley defined by the pulley surfaces of the roller supports located at respective roller ends, it is understood that the groove or pulley may be defined anywhere along the length of the roller as well.

Because the pulley 264 or pulleys 264a and 264b of a given roller assembly 15 are defined by pulley surfaces located on opposite sides of the arm 10 or pair of arms 10a and 10b, a gap 261 is again defined due to the presence of the arm located there-between. Referring again to FIG. 9, to ensure that a drive belt, when engaged with a given pulley, does not contact the upper and lower edges 30 and 35 or rounded forward end 25 of a given arm (only arm 10, belt 70 and central roller 135 illustrated by example) located respectively within a given gap 261, each pulley (i.e., pulley 264) defines a radius PR, again as measured from an axis 262 defined by the roller assembly bores 195 of the arm or arms, that the exceeds the end radius ER of the arms' rounded ends defining each arm's top-to-bottom depth. Also, to ensure that the given drive belt engaged with a given arm is not drawn into the respective gap 261 defined therein, each pulley defines a width that both accommodates the drive belt and exceeds that of the gap.

As illustrated in FIGS. 7 and 8, one end 95 of the at least one extension roller 90 is adapted for removable connection with at least the opposite outer ends 85a and 85b of the base roller assembly 80. If utilizing a plurality of extension rollers 90 with each defining opposite ends 95 and 100, one end 95 of each extension roller is adapted for removable connection with the opposite outer ends 85a and 85b of the base roller assembly 80. In additional embodiments, the one end 95 of each extension roller 90 is also adapted for removable connection with the other end 100 of each extension roller of the plurality, thus making each extension roller removably connectable with one another in addition to being removably connectable with the opposite outer ends of the base roller assembly. Thus, the removable connection of each extension roller 90 with the opposite outer ends 85a and 85b of the base roller assembly 80 preferably comprises a circumferal protuberance 265 located at the one end 95 of each extension roller, and the receiver 216 located at each opposite outer end of the base roller assembly. In additional embodiments, the removable connection of each extension roller 90 with the opposite outer ends 85a and 85b of the base roller assembly 80, and also with the other end 100 of each extension roller, preferably comprises a circumferal protuberance 265 located at the one end 95 of each extension roller, and the receiver 216 located at each opposite outer end of the base roller assembly and also at the other end 100 of each extension roller.

The protuberance defines inner and outer surfaces 275 and 280 that define a circumferal outer end 285, while the receiver 216 defines an inner surface 290. Each protuberance 265 and receiver 216 is adapted for mating engagement with one another, with each protuberance 265 preferably extending outwardly from the end 95 of each extension roller 90 to define a length to the circumferal outer end 285 that preferably corresponds with about the depth of each receiver 216, as defined by the location of the abutment 235. However, it is understood that each protuberance 265 may extend outwardly from the end 95 of each extension roller 90 to define any other length as well. The protuberance 265 is each preferably comprised of aluminum and is preferably bonded to the inner surface 200 of the respective rollers with an adhesive. However, it is understood that the protuberance 265 may be comprised of any lightweight, rigid material as well. It is further understood that it may be connected to the respective roller using a resistance fit of any mechanical means understood in the art. Each protuberance may also be unitary with or defined in each extension roller itself as well. While the foregoing discussion utilizes FIGS. 7 and 8 to illustrate the respective structures of the receivers 216 and protuberances 265 that facilitate their mating engagement with one another, is understood that the receivers of FIGS. 5 and 6 have the same structural elements to facilitate the same mating engagement with the protuberances of FIGS. 7 and 8 as well.

The removable connection of each extension roller 90 with the opposite outer ends 85a and 85b of the base roller assembly 80, and also with the other end 100 of each extension roller, preferably further comprises a securement means 295 for removably securing the roller assembly components to one another. However, it is understood that alternate embodiments of the variable-length roller assembly 15 may not include a securement means. In the embodiments of the variable-length roller assembly 15 illustrated in FIGS. 7 and 8, the securement means comprises a twist-lock 300. As illustrated therein, the twist-lock 300 includes a keyway 305 defined in the outer surface 280 of the circumferal protuberance 265, a pin 310 inwardly protruding from the inner surface 290 of the receiver 216, and a compression spring 315 defining inner and outer ends 320 and 325 located within the receiver.

The keyway 305 comprises a substantially “L-shaped” void 330 defining an entrance opening 335 in the circumferal end 285 of the protuberance 265 and an inward stop 340 and stay 345 within the protuberance. The pin 310 of each receiver 270 is adapted for operable engagement with the keyway 305 of each protuberance 265 via the entrance opening 335 of the keyway 305 defined in the circumferal end 285 of the protuberance 265. With regard to the receivers 216 located at the opposite outer ends 85a and 85b of the base roller assembly 80, the compression spring 315 is located at each shaft end 190a and 190b between the pin 310 and the nut 245. With regard to the receivers 216 located at the other end 100 of each at least one extension roller 90, the compression spring 315 is located between the pin 310 and abutment 235. Each compression spring 315 has a diameter to define an outer spring end 325 that is substantially co-terminus with the circumferal end 285 of each protuberance 265 such that the outer end of the spring abuts the circumferal end of the protuberance when the pin 310 of the receiver 270 is operably engaged with the keyway 305 of the respective protuberance 265.

To removably connect a given extension roller 90 with the base roller assembly 80 or other extension roller 90 of the variable-length roller assembly 15, the circumferal protuberance 265 of the extension roller is inserted into the receiver 216 located at the opposite outer ends 85a and 85b of the base roller assembly or the other end 100 of the other extension roller of the plurality. The protuberance 265 and receiver 216 are preferably rotated in relation to one another until the pin 310 of the receiver comes into alignment with the entrance opening 335 of the keyway 305 defined in the protuberance. The protuberance 265 of the extension roller 90 is thereafter co-axially inwardly translated in relation to the receiver 216 until the pin 310 of the receiver abuts the stop 340 of the keyway 305, with the circumferal end 285 of the protuberance abutting the outer end 325 of the compression spring 315. The protuberance 265 and receiver 216 are preferably further rotated in relation to one another until the pin 310 of the protuberance and the stay 345 of the receiver engage one another, thereby engaging the twist-lock 300. When the pin 310 and stay 345 engage one another, the compression spring 315, located between the circumferal end 285 of the protuberance 265 and the nut 245 of the shaft end 190a or 190b, influences the protuberance in an outwardly direction to prevent the pin and stay from becoming disengaged from one another.

To disconnect the given extension roller 90 from the base roller assembly 80 or other extension roller, the protuberance 265 of the extension roller is again co-axially inwardly translated in relation to the receiver 216 to counter-act the outward influence of the compression spring 315 until the pin 310 and stay 345 become disengaged from one another. The protuberance 265 and receiver 270 are thereafter rotated in relation to one another until the pin 310 of the protuberance comes into alignment with the entrance opening 335 of the keyway 305. The protuberance 265 of the extension roller 90 is thereafter co-axially outwardly translated in relation to the receiver 216 until the pin 310 of the receiver exits the entrance opening 335 of the keyway 305, with the circumferal end 285 of the protuberance no longer abutting the outer end 325 of the compression spring 315 and thereby disengaging the twist-lock 300. The circumferal protuberance 265 of the extension roller 90 is thereafter withdrawn from the receiver 216 located at the opposite outer ends 85a and 85b of the base roller assembly 80 or from the other end 100 of the other extension roller 90 of the plurality.

Although FIGS. 7 and 8 illustrate the securement means 295 as comprising a twist-lock 300, it is understood that the securement means may comprise other mechanisms as well. For example, FIG. 10 illustrates the securement means 295 of the variable-length roller assembly 15 as comprising a snap-fit 350. As illustrated therein, the snap-fit 350 includes a snap-pin 355 connected to the inner surface 275 of the circumferal protuberance 265 and a through orifice 360 defined in at least the receiver 216. The snap-pin 355 comprises a biased segment 365 connected at one end to the inner surface 275 of the protuberance 265 and having an outwardly directed protrusion 370 defined at an opposite end. The protrusion 370 is upwardly biased by the segment 365 and extends upwardly through a bore 375 defined in the protuberance 265 for mating engagement with the through orifice 360 defined in the receiver 216.

As illustrated in FIG. 10, to removably connect a given extension roller 90 with a base roller assembly 80 or other extension roller, the protrusion of the snap-pin 355 is depressed and the circumferal protuberance 265 of the extension roller is inserted into the receiver 216 located at the outer ends 85a and 85b of the base roller assembly 80 or the other end 100 of the other extension roller of the plurality. The protuberance 265 and receiver 216 are preferably rotated in relation to one another until the protrusion 370 of the snap-pin 355 of the circumferal protuberance 265 comes into alignment with the through orifice 360 defined in the respective receiver 216. The biased segment 365 of the snap-pin 355 causes the protrusion 370 to matingly engage the orifice 360, thereby engaging the snap-fit 350. When the protrusion 370 engages the orifice 360, the biased segment 365 of the snap-pin 355 influences the protrusion 370 in an outwardly direction to prevent the protrusion from disengaging from the orifice.

To disconnect the extension roller 90 from the base roller assembly 80 or other extension roller, the protrusion 370 of the snap-pin 355 is depressed through the orifice 360 of the receiver 216 to counter-act the outward influence of the biased segment 365 until the protrusion becomes disengaged from the orifice. The circumferal protuberance 265 of the extension roller 90 is thereafter withdrawn from the receiver 216 located at the opposite outer ends 85a and 85b of the base roller assembly 80 or the other end 100 of the other extension roller of the plurality.

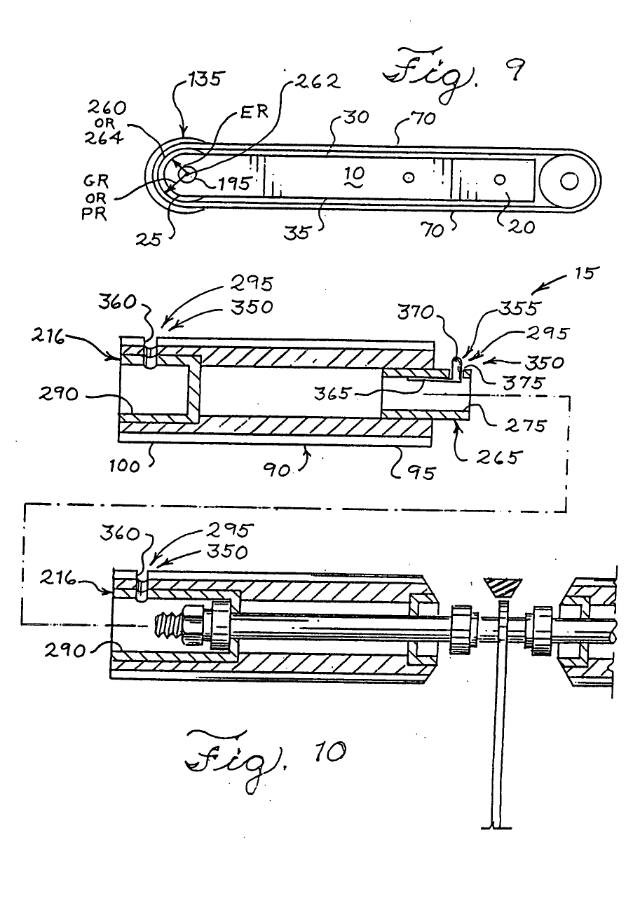

The variable-length roller assembly 15, driven by the drive belt 70 or belts 70a and 70b to rotate against various insulation mixtures and building framing members, thus utilizes base assembly and extension rollers comprised of durable materials. In one embodiment, each roller of the variable-length roller assemblies 15 (i.e., the first and second rollers, central and outer rollers, and each extension roller) is comprised of a polyurethane material having a durometer hardness of between about 60 A and about 85 D, preferably about 75 D. It is understood, however, that polyurethane rollers of other durometer hardness may be utilized, as well as rollers comprised of other materials (i.e., aluminum, plastic, rubber, etc). Referring to FIGS. 11-13, to facilitate the removal of the excess insulation mixture from building cavities and from the faces of the structural members, each roller of the variable-length roller assemblies 15 (i.e. the first and second rollers, central and outer rollers, and each extension roller) defines a textured outer surface. The textured outer surface may comprise any texture sufficient for the removal of sprayed insulation or other materials. In one embodiment, each roller defines a plurality of ribs 380 in its outer surface 205. The outer surface 205 of each roller defines between about 15 ribs and about 35 ribs, preferably about 22 ribs. The ribs 380 may be machined or cut into the outer surface 205 of each roller, or the ribs may be formed by a molding or extrusion process.

FIG. 11 illustrates an embodiment of the variable-length roller assembly 15 wherein each rib 380 has a triangular cross-section. As illustrated therein, the triangular cross-section of each rib preferably defines a base 385 having a width of between about ⅛ of an inch and about ½ of an inch, more preferably about 3/16 of an inch, and a height 390 defining a radial distance from the base of between about ⅛ of an inch and about ¼ of an inch, more preferably about 3/16 of an inch. In one embodiment, the base 385 of each rib 380 is longitudinally co-terminus with one another such that no space exists circumferentially there-between. However, it is understood that in other embodiments, the base 385 of each rib 380 is not longitudinally co-terminus with one another such that a longitudinal space is defined there-between.

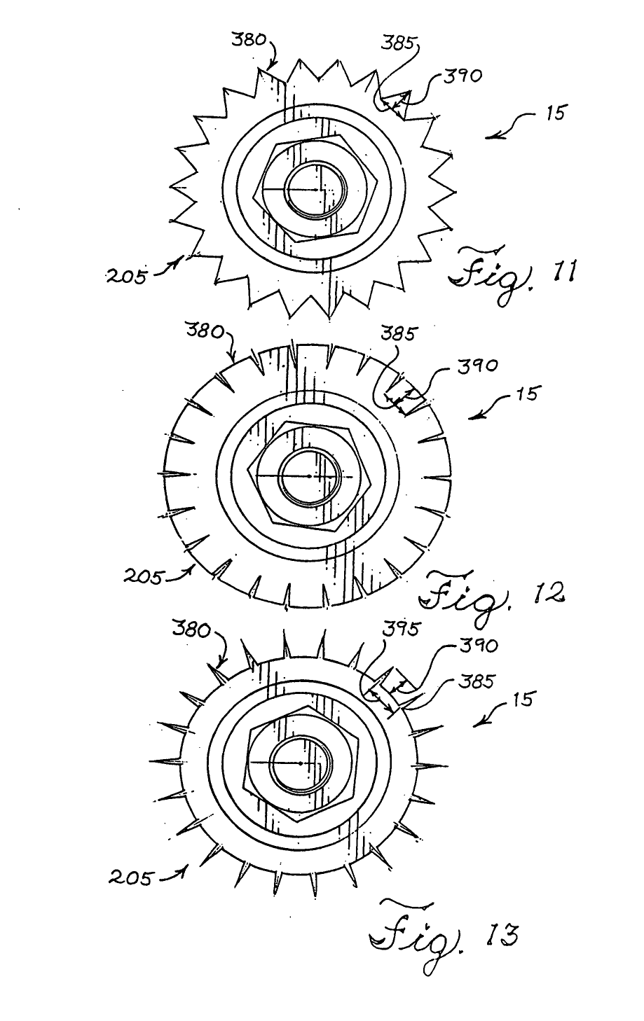

FIG. 12 illustrates an embodiment of the variable-length roller 15 wherein each rib 380 has a cross-section defining at least two right angles. As illustrated therein, the cross-section of each rib 380 preferably defines a base 385 having a width of between about ⅛ of an inch and about ½ of an inch, more preferably about 3/16 of an inch, and a height 390 defining a radial distance from the base of between about ⅛ of an inch and about ¼ of an inch, more preferably about 3/16 of an inch. In one embodiment, the base 385 of each rib 380 is again longitudinally co-terminus with one another such that no space exists circumferentially there-between. However, it is understood that in other embodiments, the base 385 of each rib 380 is not longitudinally co-terminus with one another such that a longitudinal space is defined there-between.

FIG. 13 illustrates an embodiment of the variable-length roller assembly 15 wherein each rib 385 has a cross-section defining a blade. As illustrated therein, the cross-section of each rib preferably defines a base 385. A spacing 395 of between about ⅛ of an inch and about ½ of an inch, more preferably about 3/16 of an inch, is defined between each rib 380 (i.e., blade). The cross-section of each rib also preferably defines a height 390 defining a radial distance from the base of between about ⅛ of an inch and about ¼ of an inch, more preferably about 3/16 of an inch.

In use, the rotating variable-length roller assembly is brought into contact with the framing members of a building cavity and then pulled along the framing members to contact and scrub excess or overfill insulation mixture from the cavity and members. The base roller assembly, having a length, for example, of about 16 inches, is suited for scrubbing insulation from building cavities having framing members located about every 16 inches on center. If the scrubbing of insulation from building cavities of a wider dimension is desired, one or more extension rollers may be removably connected to one or more of the opposite outer ends of the base roller assembly to facilitate such scrubbing operations. For example in one embodiment, if the framing members of a given building cavity are located about every 24 inches on center, an extension roller having a length of about 4 inches may be removably connected to each opposite outer end of the base roller assembly to change the length of the variable-length roller assembly to about 24 inches. In further embodiments, additional extension rollers may be connected to the receivers of the already-connected extension rollers of the assembly, in end-to-end relation with one another, to increase the length of the variable-length roller assembly to any desired dimension.

While this foregoing description and accompanying drawings are illustrative, other variations in structure and method are possible without departing from the spirit and scope.

I claim:

1. A variable-length roller assembly for a rotary scrubber comprising:
a base roller assembly defining opposite outer ends; and
at least one extension roller defining opposite ends, one end of the at least one extension roller adapted for removable connection with at least the opposite outer ends of the base roller assembly.

2. The variable-length roller assembly of claim 1 wherein the at least one extension roller comprises a plurality of extension rollers defining opposite ends, one end of each extension roller adapted for removable connection with the opposite outer ends of the base roller assembly.

3. The variable-length roller assembly of claim 2 wherein the base roller assembly comprises first and second rollers rotatably associated with an arm of the scrubber, the first and second rollers each defining inner and outer ends, the inner ends located proximal to the arm of the scrubber and the outer ends defining the opposite outer ends of the base roller assembly.

4. The variable-length roller assembly of claim 3 wherein the removable connection of each extension roller with the opposite outer ends of the base roller assembly comprises a circumferal protuberance located at the one end of each extension roller and a receiver located at each opposite outer end of the base roller assembly, each protuberance and receiver adapted for mating engagement with one another.

5. The variable-length roller of claim 4 wherein the removable connection further comprises a securement means.

6. The variable-length roller assembly of claim 5 wherein the securement means comprises a twist-lock.

7. The variable-length roller assembly of claim 5 wherein the securement means comprises a snap-fit.

8. The variable-length roller assembly of claim 3 wherein the first and second rollers each have a length of from about 1 inch to about 30 inches and each extension roller has a length of from about 1 inch to about 23 inches.

9. The variable-length roller assembly of claim 3 wherein the first and second rollers each have a length of from about 9 inches to about 31 inches and each extension roller has a length of from about 1 inch to about 23 inches.

10. The variable-length roller assembly of claim 3 wherein each extension roller has a length of about 7.5 inches.

11. The variable-length roller assembly of claim 3 wherein the first and second rollers and each extension roller define a plurality of ribs in an outer surface.

12. The variable-length roller assembly of claim 11 wherein the outer surface defines between about 15 ribs and about 35 ribs.

13. The variable-length roller assembly of claim 12 wherein each rib has a triangular cross-section.

14. The variable-length roller assembly of claim 12 wherein each rib has a cross-section defining at least two right angles.

15. The variable-length roller assembly of claim 12 wherein each rib has a cross-section defining a blade.

16. The variable-length roller assembly of claim 3 wherein the first and second rollers and each extension roller are comprised of a polyurethane material having a durometer hardness of between about 60 A and about 85 D.

17. The variable-length roller assembly of claim 3 wherein the first and second rollers and each extension roller are comprised of a polyurethane material having a durometer hardness of about 75 D.

18. The variable-length roller assembly of claim 2 wherein the base roller assembly comprises a central roller and a pair of outer rollers rotatably associated with a pair of arms of the scrubber, the central roller defining opposite ends located proximal to the arms of the pair and each outer roller defining inner and outer ends, the inner ends located proximal the arms of the pair and the outer ends defining the opposite outer ends of the base roller assembly.

19. The variable-length roller assembly of claim 18 wherein the removable connection of each extension roller with the opposite outer ends of the base roller assembly comprises a circumferal protuberance located at the one end of each extension roller and a receiver located at each opposite outer end of the base roller assembly, each protuberance and receiver adapted for mating engagement with one another.

20. The variable-length roller of claim 19 wherein the removable connection further comprises a securement means.

21. The variable-length roller assembly of claim 20 wherein the securement means comprises a twist-lock.

22. The variable-length roller assembly of claim 20 wherein the securement means comprises a snap-fit.

23. The variable-length roller assembly of claim 18 wherein the central roller has a length of from about 2 inches to about 62 inches, each outer roller has a length of from about 1 inch to about 29.5 inches, and each extension roller has a length of from about 1 inch to about 28.5 inches.

24. The variable-length roller assembly of claim 18 wherein the central roller has a length of about 3 inches, each outer roller has a length of from about 1 inch to about 29.5 inches, and each extension roller has a length of from about 1 inch to about 28.5 inches.

25. The variable-length roller assembly of claim 18 wherein each extension roller has a length of about 7.5 inches.

26. The variable-length roller assembly of claim 18 wherein the central and outer rollers and each extension roller define a plurality of ribs in an outer surface.

27. The variable-length roller assembly of claim 26 wherein the outer surface defines between about 15 ribs and about 35 ribs.

28. The variable-length roller assembly of claim 27 wherein each rib has a triangular cross-section.

29. The variable-length roller assembly of claim 27 wherein each rib has a cross-section defining at least two right angles.

30. The variable-length roller assembly of claim 27 wherein each rib has a cross-section defining a blade.

31. The variable-length roller assembly of claim 18 wherein the central and outer rollers and each extension roller are comprised of a polyurethane material having a durometer hardness of between about 60 A and about 85 D.

32. The variable-length roller assembly of claim 18 wherein the central and outer rollers and each extension roller are comprised of a polyurethane material having a durometer hardness of about 75 D.

33. The variable-length roller assembly of claim 2 wherein the one end of each extension roller is also adapted for removable connection with the other end of each extension roller of the plurality.

34. The variable-length roller assembly of claim 33 wherein the base roller assembly comprises first and second rollers rotatably associated with an arm of the scrubber, the first and second rollers each defining inner and outer ends, the inner ends located proximal to the arm of the scrubber and the outer ends defining the opposite outer ends of the base roller assembly.

35. The variable-length roller assembly of claim 34 wherein the removable connection of each extension roller with the opposite outer ends of the base roller assembly and also with the other end of each extension roller comprises a circumferal protuberance located at the one end of each extension roller and a receiver located at each opposite outer end of the base roller assembly and also at the other end of each extension roller, each protuberance and receiver adapted for mating engagement with one another.

36. The variable-length roller of claim 35 wherein the removable connection further comprises a securement means.

37. The variable-length roller assembly of claim 36 wherein the securement means comprises a twist-lock.

38. The variable-length roller assembly of claim 36 wherein the securement means comprises a snap-fit.

39. The variable-length roller assembly of claim 34 wherein the first and second rollers each have a length of from about 1 inch to about 30 inches and each extension roller has a length of from about 1 inch to about 23 inches.

40. The variable-length roller assembly of claim 34 wherein the first and second rollers each have a length of from about 9 inches to about 31 inches and each extension roller has a length of from about 1 inch to about 23 inches.

41. The variable-length roller assembly of claim 34 wherein each extension roller has a length of about 7.5 inches.

42. The variable-length roller assembly of claim 34 wherein the first and second rollers and each extension roller define a plurality of ribs in an outer surface.

43. The variable-length roller assembly of claim 42 wherein the outer surface defines between about 15 ribs and about 35 ribs.

44. The variable-length roller assembly of claim 43 wherein each rib has a triangular cross-section.

45. The variable-length roller assembly of claim 43 wherein each rib has a cross-section defining at least two right angles.

46. The variable-length roller assembly of claim 43 wherein each rib has a cross-section defining a blade.

47. The variable-length roller assembly of claim 34 wherein the first and second rollers and each extension roller are comprised of a polyurethane material having a durometer hardness of between about 60 A and about 85 D.

48. The variable-length roller assembly of claim 34 wherein the first and second rollers and each extension roller are comprised of a polyurethane material having a durometer hardness of about 75 D.

49. The variable-length roller assembly of claim 33 wherein the base roller assembly comprises a central roller and a pair of outer rollers rotatably associated with a pair of arms of the scrubber, the central roller defining opposite ends located proximal to the arms of the pair and each outer roller defining inner and outer ends, the inner ends located proximal the arms of the pair and the outer ends defining the opposite outer ends of the base roller assembly.

50. The variable-length roller assembly of claim 49 wherein the removable connection of each extension roller with the opposite outer ends of the base roller assembly and also with the other end of each extension roller comprises a circumferal protuberance located at the one end of each extension roller and a receiver located at each opposite outer end of the base roller assembly and also at the other end of each extension roller, each protuberance and receiver adapted for mating engagement with one another.

51. The variable-length roller of claim 50 wherein the removable connection further comprises a securement means.

52. The variable-length roller assembly of claim 51 wherein the securement means comprises a twist-lock.

53. The variable-length roller assembly of claim 51 wherein the securement means comprises a snap-fit.

54. The variable-length roller assembly of claim 49 wherein the central roller has a length of from about 2 inches to about 62 inches, each outer roller has a length of from about 1 inch to about 29.5 inches, and each extension roller has a length of from about 1 inch to about 28.5 inches.

55. The variable-length roller assembly of claim 49 wherein the central roller has a length of about 3 inches, each outer roller has a length of from about 1 inch to about 29.5 inches, and each extension roller has a length of from about 1 inch to about 28.5 inches.

56. The variable-length roller assembly of claim 49 wherein each extension roller has a length of about 7.5 inches.

57. The variable-length roller assembly of claim 49 wherein the central and outer rollers and each extension roller define a plurality of ribs in an outer surface.

58. The variable-length roller assembly of claim 57 wherein the outer surface defines between about 15 ribs and about 35 ribs.

59. The variable-length roller assembly of claim 58 wherein each rib has a triangular cross-section.

60. The variable-length roller assembly of claim 58 wherein each rib has a cross-section defining at least two right angles.

61. The variable-length roller assembly of claim 58 wherein each rib has a cross-section defining a blade.

62. The variable-length roller assembly of claim 49 wherein the central and outer rollers and each extension roller are comprised of a polyurethane material having a durometer hardness of between about 60 A and about 85 D.

63. The variable-length roller assembly of claim 49 wherein the central and outer rollers and each extension roller are comprised of a polyurethane material having a durometer hardness of about 75 D.

64. A variable-length roller assembly for a rotary scrubber comprising:
a base roller assembly defining opposite outer ends;
a plurality of extension rollers defining opposite ends, one end of each extension roller adapted for removable connection with the opposite outer ends of the base roller assembly and also with the other end of each extension roller of the plurality, the removable connection of each extension roller with the opposite outer ends of the base roller assembly and also with the other end of each extension roller comprising a circumferal protuberance located at the one end of each extension roller and a receiver located at each opposite outer end of the base roller assembly and also at the other end of each extension roller, each protuberance and receiver adapted for mating engagement with one another, the removable connection further comprising a securement means.

65. In a rotary scrubber having a roller assembly rotatably associated with at least one arm, the improvement comprising a base roller assembly adapted for use as the roller assembly and defining opposite outer ends, and a plurality of extension rollers defining opposite ends, one end of each extension roller adapted for removable connection with the opposite ends of the base roller assembly and also with the other end of each extension roller of the plurality.
